(19) United States
(12) Patent Application Publication
(10) Pub. No.: US 2015/0330106 A1
(43) Pub. Date: Nov. 19, 2015

(54) SYSTEM AND METHOD TO SECURE AN AUTOMATED SWING GATE OPERATOR TO A GATE

(71) Applicants: Robert R. Coffman, McKinney, TX (US); Lorton E. Trent, McKinney, TX (US)

(72) Inventors: Robert R. Coffman, McKinney, TX (US); Lorton E. Trent, McKinney, TX (US)

(21) Appl. No.: 14/276,992

(22) Filed: May 13, 2014

(51) Int. Cl. E05B 65/00; E05B 65/10; E06B 11/02; E05B 67/38; E05F 15/72

(52) U.S. Cl. CPC E05B 65/0007; E05B 67/38; E05F 15/72; E06B 11/02; E05B 65/1033

(57) ABSTRACT

A system is described herein that includes a device to lock a pin used to connect an automated swing gate operator arm to a gate.

### CROSS REFERENCE TO RELATED APPLICATIONS

Applicant claims benefit and priority based on U.S. Provisional Patent Application Ser. No. 61/822,632, filed on May 13, 2014, which the entire content is incorporated herein by reference to the extent permitted by applicable law.

### BRIEF DESCRIPTION OF THE DRAWINGS

For a more complete understanding of the present invention, including its features and advantages, reference is now made to the detailed description of the invention taken in conjunction with the accompanying drawing in which:

FIG. 1 illustrates a modified pin of the present invention;

FIGS. 2A and 2B illustrates two views of a modified block interconnects with the modified pin and a padlock;

FIG. 3 illustrates how the modified pin interconnects with the modified block;

FIG. 4 illustrates the modified pin and the modified block attached to a gate padlock in an open position;

FIG. 5 illustrates the modified pin and the modified block attached to the gate padlock in a closed position;

FIG. 6 illustrates the modified pin attached to a gate and a fence;

FIG. 7 illustrates the modified pin and the modified block attached to the gate and the fence;

FIG. 8 illustrates the modified pin and the modified block attaches to the gate and the fence and the padlock in the open position;

FIG. 9 illustrates the modified pin and the modified block attaches to the gate and the fence and the padlock in the closed position;

FIG. 10 illustrates more details of the fence of FIG. 9;

FIG. 11 is another view of the elements of the present invention; and

FIG. 12 illustrates yet another view of the elements of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

The present invention includes a system to lock an automated swing gate operator arm to a gate.

In the past, Fire Marshals ultimately require a manual release for any automated gate across a fire lane to gain access to the property in case of an emergency. Generally, a Knox™ Fire Department padlock secures a manual release. Currently, two Knox™ padlocks are in use and have a ⅜″ or 7/16″ diameter shank. However, gate pins to attach an automated swing gate arm to a gate are typically ½″ in diameter. One issue that occurs with the present solution is drilling a ⅜″ or larger hole through the pin to accommodate current padlock shanks leaves too little metal to be structurally sound.

Currently, a solution does not exist that addresses this issue. The present invention, the “911 Pin Lock”, resolves the problem of complying with Fire Marshals requirements for gate operators across fire lanes, as well as providing a way to secure a gate operator arm for a residential or commercial consumer installation.

The 911 Pin Lock provides a grooved pin (“modified pin”) and a milled metal block (“modified block”). The modified pin is inserted through a gate bracket and a gate operator arm, and the modified block slides over the end of the modified pin. A hole in the side of the modified block allows a shank of a padlock to be inserted, whereby the shank of the padlock engages a groove in the modified pin thereby securing the pin.

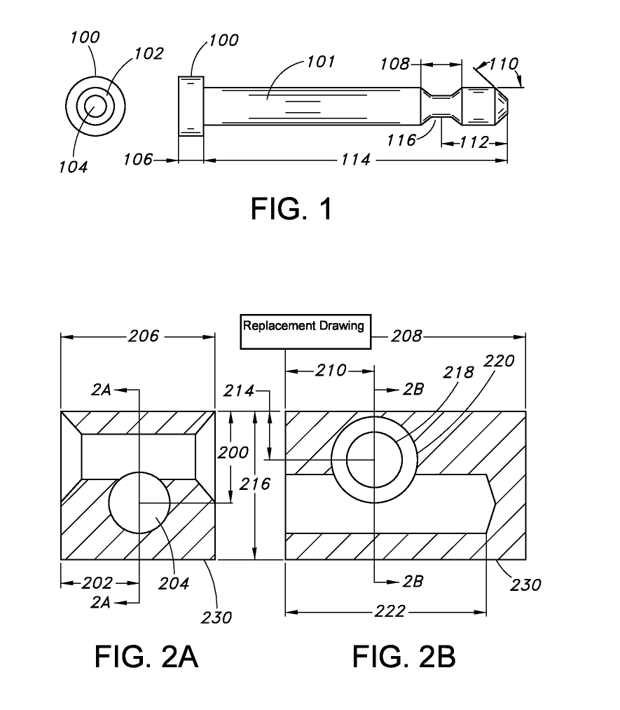

Now referring to FIGS. 1, 2A and 2B, the components of the 911 Pin Lock consists of two items, a ½″ diameter 102 by 3 ½″ length 114 pin with a ¾″ head 100 (together referred to as the modified pin 100) and a 2″ length 208 by 1 ¼″ width 216 modified block 230. The component materials can consist of, but not limited to, aluminum, or steel.

One embodiment of the system consists of a 0.5″ hole 220 drilled offset into the modified block 230 to a depth of 1.25″ 206 and accepts the modified pin 100. A 0.453″ diameter padlock hole 220 is then drilled through the modified block 230 at a 90° angle opposed to the ½″ pin hole 204, and intersecting the pin hole 204. In addition, the modified pin 100 has a milled curved groove 116 in the shank 101 of the pin 100. Thus, when the modified pin 100 is inserted into the modified block 230, through the pin hole 204, the groove 116 creates a pathway to accept a shank 218 of a padlock.

Specifically in this embodiment, the modified pin 100 includes a head with a 0.165 width 106, a shank 101 of 3.5″ length 114, 0.50″ circumference 102 with the groove 116 milled at a radius of 0.1875″ and 0.602″ width 108 and a 0.235″ circumference 104. The distance 112 from the center of the groove 116 to the end of the shank 101 opposite of the head is 1.0″ in length. In addition, the end of the shank in this embodiment has a 45 degree 110.

In addition, referring to cross section 2A in FIG. 2A as depicted by FIG. 2B and cross section 2B as depicted in FIG. 2A, this embodiment depicts the modified block 230 with a distance 200 from a center of the pin hole 204 of 0.78″. The distance 214 from the center of the padlock hole 220 is 0.425″. The distance 202 from the center of the pin hole 204 one end of the modified block is 0.625″. The distance 222 from the end of the pin hole 204 to the opening of the modified block 230 is 1.75″.

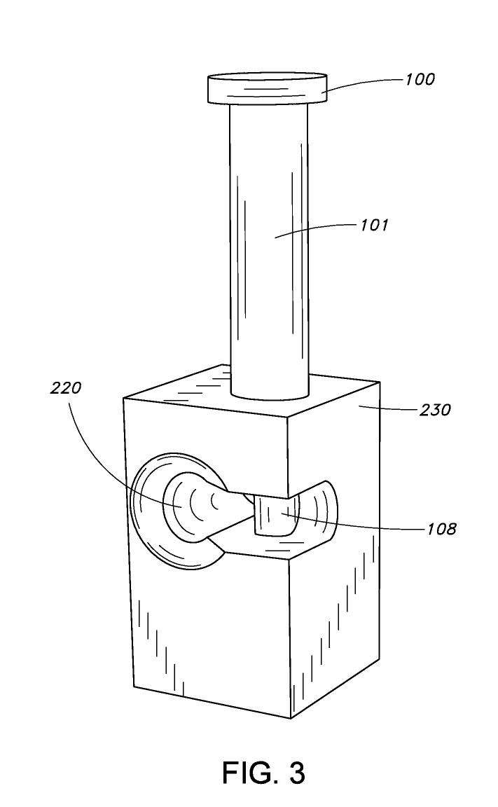

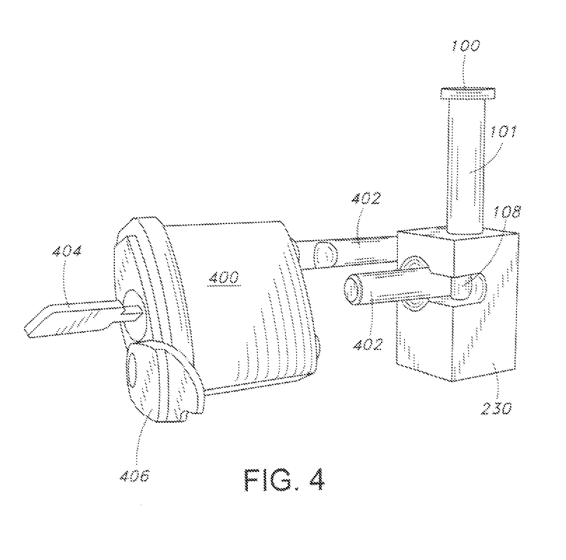

FIG. 3 illustrates how the modified pin 100, 101 interconnects with the modified block 230. As shown, the groove 116, 108 indicates the intersection of the padlock hole 220.

FIG. 4 illustrates the modified pin 100, 101 pin and the modified block 230 attached to a shank 402 of a gate padlock 400 in an open position and while a key 404 is inserted.

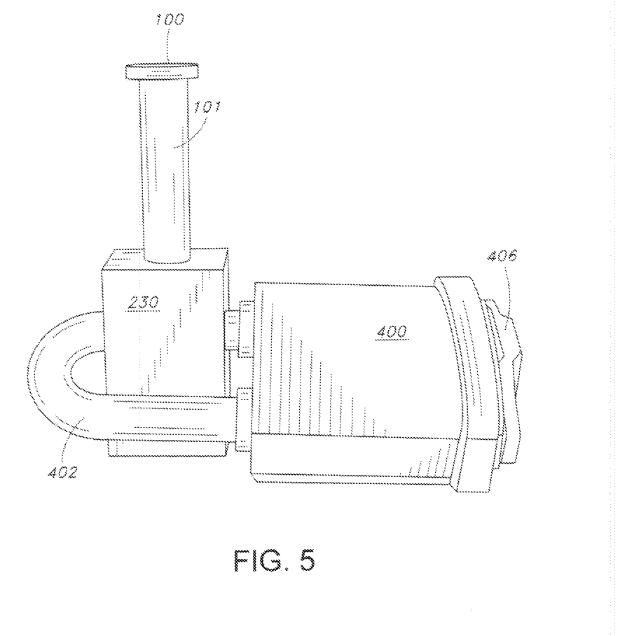

FIG. 5 illustrates the modified pin 100, 101 pin and the modified block 230 attached to the shank 402 of the gate padlock 400 in a key hole cover 406, both is a closed position.

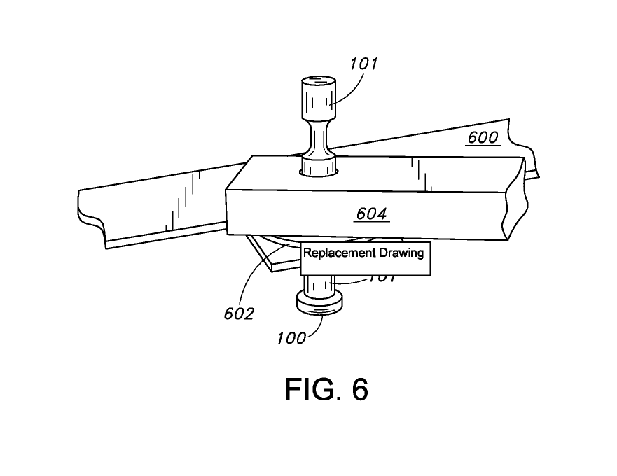

FIG. 6 illustrates the modified pin 100, 101 attached to a gate 604 and a fence railing 600. In this embodiment, a washer 602 is positioned between the fence railing 600 and the gate 604 before the modified pin 100, 101 is inserted into gate 604.

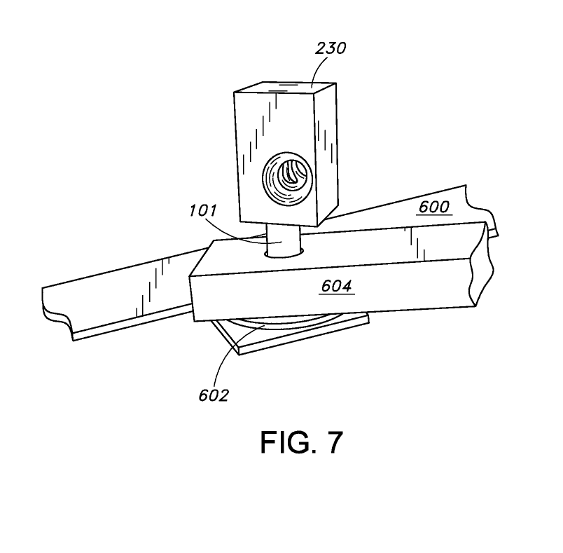

FIG. 7 illustrates the system depicted in FIG. 6 with the modified block 230 attached.

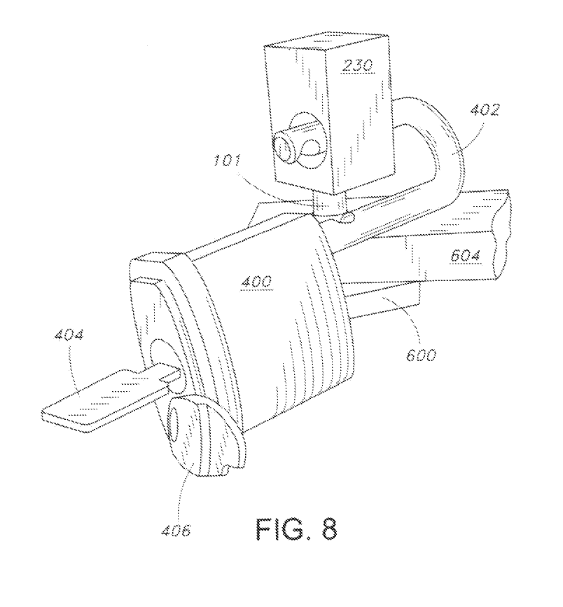

FIG. 8 illustrates the shank 402 of the padlock 400, in the open position, attached to the modified pin 101 and the modified block 230 along with the gate 604 and fence railing 600.

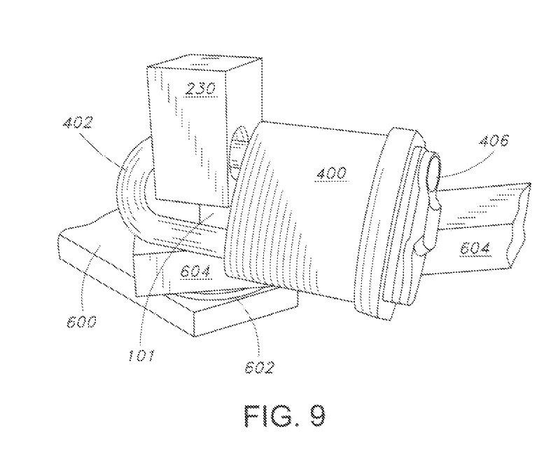

FIG. 9 illustrates the shank 402 of the padlock 400 and key hole cover 406, in the closed position, attached to the modified pin 101 and the modified block 230 along with the gate 604 and fence railing 600.

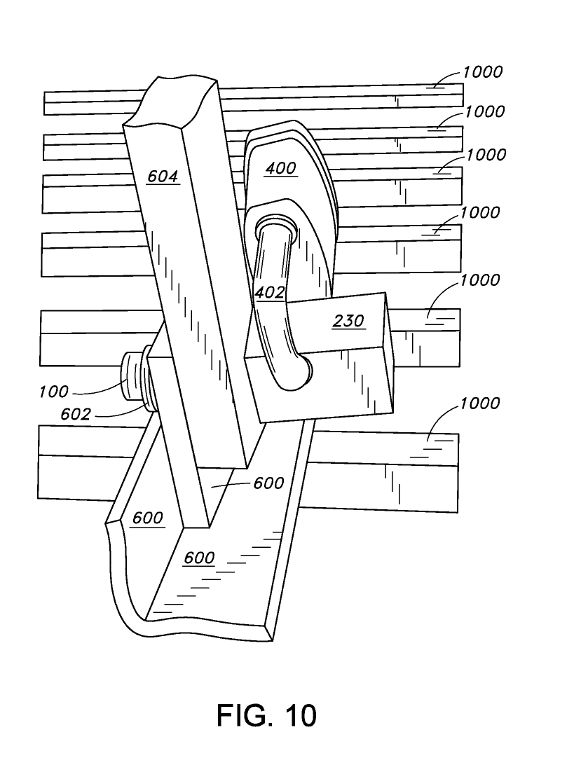

FIG. 10 is another view of the elements in FIG. 9 along with fence posts 1000 attached to the fence railing 600.

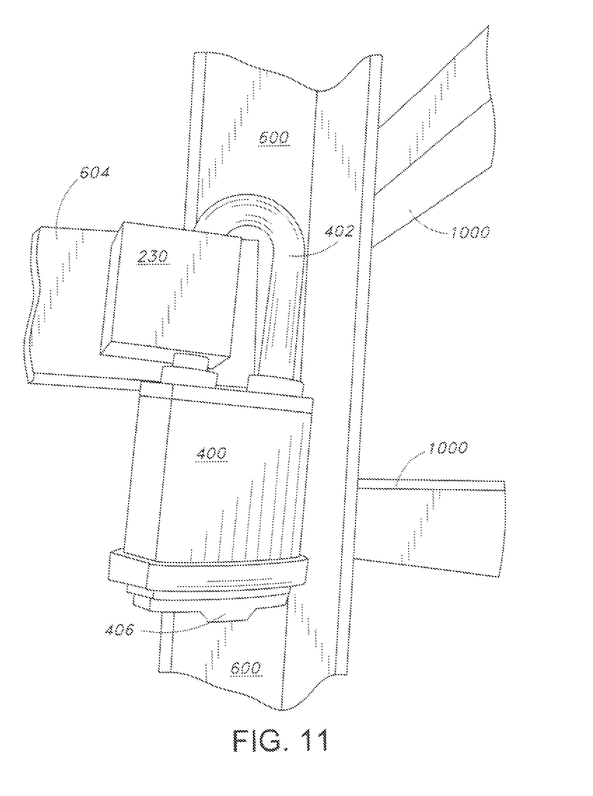

FIG. 11 is yet another view of the elements of FIG. 9.

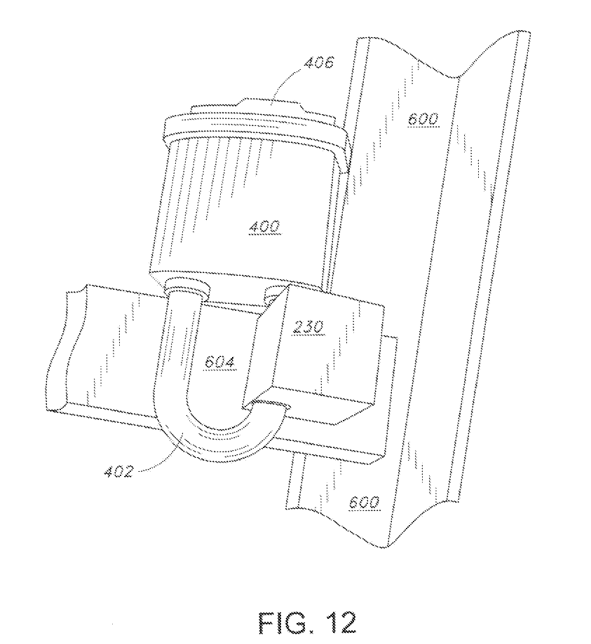

FIG. 12 illustrates a closer view of the elements of FIG. 9.

In this embodiment, a fire marshal or other user could cut the shank of the modified pin to remove the gate if necessary.

Another embodiment of the present invention includes two modified blocks and a longer shank of the modified pin that interconnects the modified blocks. In this embodiment, a first block attaches to a padlock and one end of the longer modified pin, in a similar method as the embodiment illustrated above, but is connected before a second modified block with a second padlock attaches the gate and fence railing. This embodiment would expose the shank between the first and second block to provide a user a wider area to cut the shank if needed.

Although this invention has been described with reference to an illustrative embodiment, this description is not intended to limit the scope of the invention. Various modifications, such as dimensions of the padlock, the modified pin and the modified block, and combinations, as of the illustrative embodiments as well as other embodiments of the invention will be apparent to persons skilled in the art upon reference to the description. It is therefore intended that the appended claims accomplish any such modifications or embodiments.

We claim:

1. A system that allows access to a gate in case of emergency or other like circumstances, the system comprising:
a gate for secured access to a property;
a padlock to secure access to the property;
an attachment block that adjoins the padlock to the gate; and
a modified pin that allows emergency personal or the owner of the property to gain access to the property in case of malfunction of the gate, power outage or such circumstances.

2. A system that allows access to a gate in case of emergency or other like circumstances, the system comprising:
a gate for secured access to a property;
a plurality of padlocks to secure access to the property;
a plurality of attachment blocks that adjoin the plurality of padlocks to the gate; and
a modified pin that allows emergency personal or the owner of the property to gain access to the property in case of malfunction of the gate, power outage or such circumstances.
